(19) United States
(12) Patent Application Publication
(10) Pub. No.: US 2019/0241010 A1
(43) Pub. Date: Aug. 8, 2019

(54) Componentized Assemblable Wall Hanging and Method of Enabling Printing Thereupon

(71) Applicant: Jeffry Basinkewitz, Littleton, CO (US)

(72) Inventor: Jeffry Basinkewitz, Littleton, CO (US)

(21) Appl. No.: 15/876,105

(22) Filed: Jan. 19, 2018

(51) Int. Cl. B44C 5/04; G09F 15/02; G09F 15/00

(52) U.S. Cl. CPC B44C 5/043; B44C 5/0461; G09F 15/0062; G09F 15/02

(57) ABSTRACT

A componentized assemblable wall hanging and method of enabling printing thereupon is presented to enable production of large designs and images upon an anterior surface of a componentized wall hanging whereby disassembly of the wall hanging after printing is completed enables compact packaging for shipment and reassembly upon delivery is thence expediently afforded with minimal tools required for installation.

### BACKGROUND OF THE INVENTION

Various types of wall hangings are known in the prior art. Most are comprised of a common body, typically planar in extent, having a continuous anterior surface upon which an image or other design is rendered. However such construction form a single structure presents increased costs when shipping the wall hanging to an end user due to the relative size and expanse of the wall hanging.

Componentized wall hangings that are devised to be assembled upon receipt of delivery for installation, having multiple parts whereby the anterior surface is composed when assembled whole, present additional problems when applying the image to the anterior surface since the independent parts may be movable relative one another and the printer head, operating thereover, may strike against any uneven surface when crossing between the independent parts. Problems of maintaining the levelness likewise arises, especially since it is hard to uphold a vacuum beneath separable parts. This is especially the case when printing large images or designs wherein the workpiece must be held fast and true, since the weight of the parts involved often corrupt the congruence of the anterior surface and render printing difficult or impossible.

Attempts to solve this issue in the present state of the art are less than satisfactory. Printing upon a single workpiece's anterior surface, and then cutting into component parts for shipping and reassembly after delivery, corrupts the congruence of the image as at least the width of the kerf of the saw blade is lost. The image is subsequently disjointed when the parts are reassembled. Printing on individual components in serial operations presents a congruent image upon assembly of the finished product, however it increases production time and therefore cost.

What is needed is a componentized assemblable wall hanging and method of enabling printing thereupon which enables rapid, single-run printing to the anterior surface without effecting printer head strikes thereaginst, while enabling disassembly of the finished product for compact, efficient shipping and reassembly upon receipt of delivery for expedient installation. Thus large and expansive wall hangings on a variety of substrates (such as, in a preferred embodiment herein contemplated, for example wood) are creatable and shippable to an end user with relative efficiency and ease.

### FIELD OF THE INVENTION

The present invention relates to a componentized assemblable wall hanging and method of enabling printing thereupon whereby large and expansive wall hangings are producible and shippable with relative cost efficiency for delivery to an end user. Wall hangings composed of bulky material, such as for example, wood, are thereby producible and distributable to consumers for reassembly upon receipt.

The present invention has been devised to enable printing upon an anterior surface of a wall hanging, said anterior surface comprised of a plurality of slat members secured adjacently together into a plurality of rows and maintained to present the anterior surface as a congruent plane by action of, in a first embodiment, a plurality of transverse strut members secured upon a posterior surface across each of the plurality of rows and, in a second embodiment, by action of a plurality of frame sections devised to bound the plurality of slat members perimetrically therebetween.

A single print run is thereby enabled to print a large image or design upon the anterior surface. Disassembly is expediently effected by removal of the plurality of transverse strut members in the first embodiment, or removal of the plurality of frame sections in the second embodiment. Each of the plurality of slat members is thence stackable together alongside the plurality of transverse strut members or frame sections, as case may be, and shippable as a compacted package. Upon receipt of delivery, the end user is enabled to expediently reassemble the wall hanging for installation with simple hand tools alone, such as, for example, a screwdriver or an Allen key.

### SUMMARY OF THE INVENTION

The general purpose of the componentized assemblable wall hanging and method of enabling printing thereupon, described subsequently in greater detail, is to enable efficient production of large and expansive wall hangings having images or designs produced by a single print run upon an anterior surface, comprised of wood or other substrate, maintained congruent to prevent printer head strikes. Further, the present invention devises an efficient means of shipment and expedient reassembly for installation with minimal tools required, irrespective of the size and expanse of the assembled whole.

The terms “image” and “design”, as used herein throughout, are taken to include any image or design that presents an aesthetic concern to a viewer and may include, for example, works of art, lettering, colors, shapes, geometries, or other images and/or designs. The term “wall hanging” is interpreted generally to include generally planar bodies installable to a wall surface as decorations or art.

The present componentized assemblable wall hanging and method of enabling printing thereupon, therefore, includes a plurality of slat members devised for securement adjacently disposed in edge-to-edge contact in a contiguous plurality of rows. Each of the plurality of slat members is machined to present an even, planar anterior surface congruently maintained when each of said plurality of slat members is secured together adjacently. Each of the plurality of slat members may secure together by action of interlocking edges, such as tongue and groove interconnection, or other edge-to-edge interconnectability, whereby the anterior surface is maintained congruently between and across each of the plurality of slat members without appreciable deviation from a common plane.

Congruence of the anterior surface when the plurality of slat members is assembled is important to enable printing upon the anterior surface. Deviations between each of the plurality of slat members can effect striking of the printer head, scuffle printing, and waste resources effecting time and cost. A congruent anterior surface must not only be presented to the printer head during printing, but must be maintained throughout printing even in large industrial printing operations.

To maintain congruence of the anterior surface and prevent the plurality of slat members from folding, bending, or otherwise reorienting out of a congruent plane relative one another, a plurality of transverse strut members is devised in a first embodiment to secure upon a posterior surface of the plurality of slat members and fasten across the plurality of rows. The plurality of transverse strut members maintain each of the plurality of slat members tautly connected in edge-to-edge engagement whereby pressure applied to the anterior surface during printing does not dislodge or disrupt the planar congruence of the anterior surface maintained by the plurality of slat members. Printer head strikes are thus preventable. Further, the transverse strut members are configured to enable suspension of the wall hanging from a wall fastener whereby, once assembled together subsequent delivery to an end user, the end user is readily and expediently able to hang the wall hanging from at least one wall fastener ensured that the wall hanging is centered and level for prompt display.

Large and expansive wall hangings are thus contemplated for production by a single print run without impeding action of the printer head moving across an anterior surface composed of a plurality of slat members. Substrates of bulky materials are thus contemplated as the workpiece upon which the image or design may be printed. Substrates such as wood, for example, lend particular aesthetics to the wall hanging and impart texture to the image or design printed thereupon. Shipping of the wall hanging is nonetheless enabled cost efficiently, even where substrates such as wood are used, because the wall hanging is dissasemblable for compact packaging.

A plurality of countersunk threaded inserts is disposed interior to the posterior surface of each of the plurality of slat members. A plurality of corresponding holes are sunk through each of the transverse strut members. Reassembly of the wall hanging is thus executable by simply fastening each of the transverse strut members in place by securing fasteners through the transverse strut members into each of the corresponding countersunk threaded inserts. The plurality of transverse strut members are thereby positionable automatically by the action of fastening through the prescored holes and the plurality of slat members are maintained in correct alignment. The threaded inserts ensure integrity of threadable engagement with threaded fasteners even with repeated use and reuse.

When displayed in portrait orientation, or when each of the plurality of slat members is oriented vertically when installed for view, at least one of the plurality of transverse strut members may include at least one depending point whereon the wall hanging is suspendable upon a wall fastening. The at least one depending point is positioned correctly to ensure level hanging of the wall hanging.

When the wall hanging is to be displayed in landscape orientation, or when each of the plurality of slat members is otherwise disposed horizontally when installed for view, at least one of the plurality of strut members is installable upon the posterior surface of one of the plurality of slat members at a plurality of further inserts positioned to secure the transverse strut member longitudinally oriented whereby at least one depending point disposed thereupon is likewise engageable with at least one wall fastener for level hanging of the wall hanging at installation.

In an alternate embodiment herein contemplated the plurality of slat members are secured together, not by means of the plurality of strut members, but by action of a plurality of frame sections disposed to bound the wall hanging and secure each of the plurality of slat members perimetrically. Each of the plurality of frame sections, therefore, includes an inset bead devised to contact the outermost edge of the wall hanging. A posterior contact portion is disposed right-angularly thereupon and devised to engage against the posterior surface for fastening thereto, into each of a plurality of countersunk threaded inserts. Each of the plurality of frame sections is attachable endwise to two other of the plurality of frame sections at a forty-five degree (45°) cut disposed endwise thereupon. The plurality of frame sections is devised to secure set back from the anterior surface a definite distance, such as one-sixteenth ( 1/16^{th}) of an inch whereby the printer head is enabled to pass over each frame section without contacting said frame section to enable printing upon the anterior surface in a single print run.

After printing is completed, the wall hanging is disassemblable for shipping in like manner as the previous embodiment discussed above. The plurality of slat members and frame sections are packable relatively compactly and prepared for shipping. Upon receipt of delivery, the end user expediently reassembles the wall hanging in like manner as discussed above, by securing each of a plurality of fasteners through the frame sections and into the posterior surface of the plurality of slat members. In this embodiment, the plurality of frame sections may be manufactured of a material different than the plurality of slat members to provide a frame bounding the image or design with contrasting aesthetic (such as, for example, a metal frame bounding a wooden anterior surface).

At least one depending point may be disposed upon the topmost frame section posterior contact portion. Alternately, at least one of the plurality of slat members may include a plurality of keyhole slots disposed upon the posterior surface thereof. For engagement with each of a corresponding plurality of wall fasteners. Alternately, at least one transverse strut member may be included with at least one depending point thereupon for expedient hanging of the wall hanging subsequent assembly.

Thus has been broadly outlined the more important features of the present componentized assemblable wall hanging and method of enabling printing thereupon so that the detailed description thereof that follows may be better understood and in order that the present contribution to the art may be better appreciated.

Objects of the present componentized assemblable wall hanging and method of enabling printing thereupon, along with various novel features that characterize the invention are particularly pointed out in the claims forming a part of this disclosure. For better understanding of the componentized assemblable wall hanging and method of enabling printing thereupon, its operating advantages and specific objects attained by its uses, refer to the accompanying drawings and description.

### BRIEF DESCRIPTION OF THE DRAWINGS FIGURES

FIG. 1 is an elevation view of a posterior surface having a plurality of transverse strut members secured thereto.

FIG. 2 is an elevation view of an anterior surface, maintained planar and congruent across a plurality of slat members.

FIG. 3 is an elevation view of the posterior surface illustrating securement of the plurality of slat members adjacently together into a plurality of rows by action of a plurality of fasteners attachable within a plurality of countersunk threaded inserts.

FIG. 4 is an elevation view of the posterior surface with one of the plurality of transverse strut members moved to fasten at each of a pair of further inserts whereby hanging with each of the plurality of slat members in a horizontal orientation is enabled.

FIG. 5 is an elevation view of the anterior surface and the plurality of slat members secured adjacently together by action of a plurality of frame sections additional perimetrically to secure the plurality of slat members together.

FIG. 6 is an elevation view of an anterior surface having an image printed thereto by a printer head.

FIG. 7 is an elevation view of a disassembled and packaged wall hanging prepared for shipment.

FIG. 8 is an elevation view illustrating the position of the plurality of frame sections set back from the anterior surface whereby the printer head is enabled unimpeded passage thereover.

FIG. 9 is a detail, longitudinal cross section view taken along a medial central axis to illustrate engagement of at least one of the transverse strut members upon a wall fastener. Additional transverse strut members are omitted for clarity.

FIG. 10 is an elevation view of the posterior surface having a plurality of keyhole slots disposed in at least one slat member for hanging and installation.

FIG. 11 is a detail, longitudinal cross section view taken along a medial axis to depict engagement of each of the keyhole slots to each of a pair of wall fasteners for hanging display of the wall hanging.

FIG. 12 is a diagrammatic view illustrating a method of creating a componentized assemblable wall hanging.

### DETAILED DESCRIPTION OF THE DRAWINGS

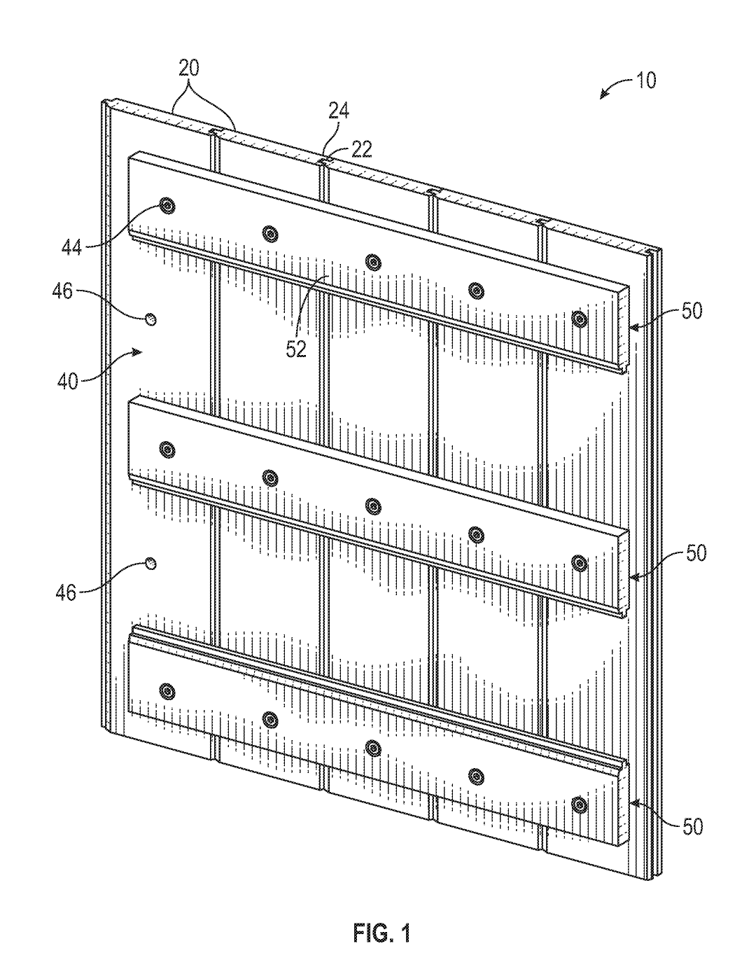

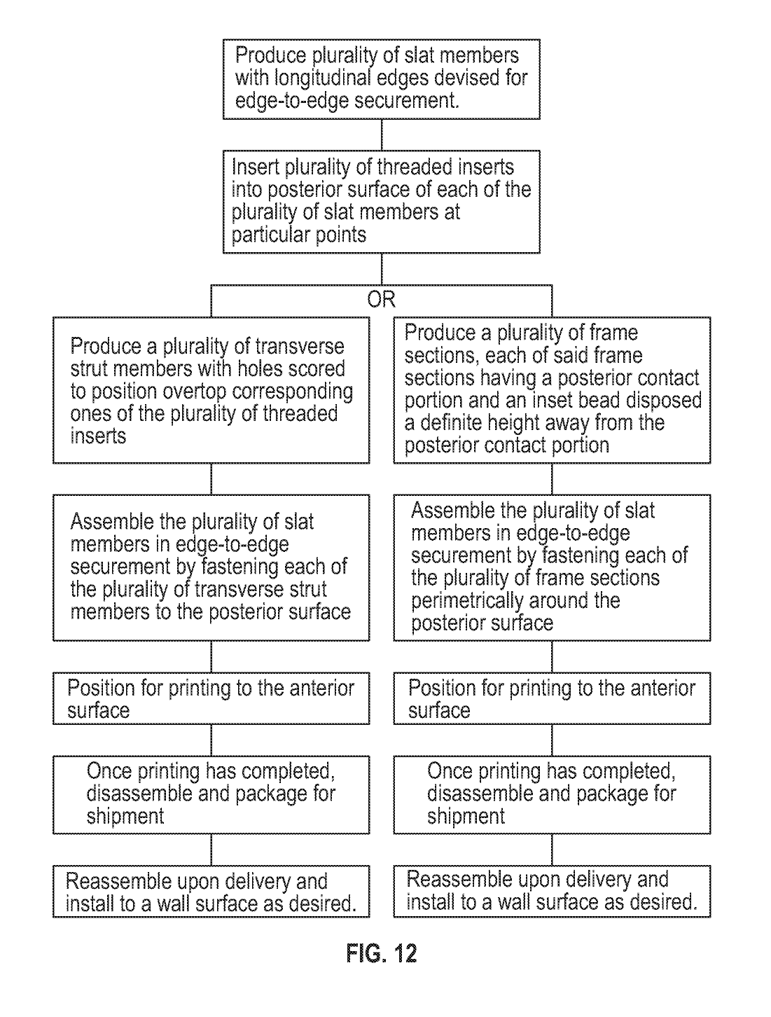

With reference now to the drawings, and in particular FIGS. 1 through 12 thereof, example of the instant componentized assemblable wall hanging and method of enabling printing thereupon employing the principles and concepts of the present componentized assemblable wall hanging and method of enabling printing thereupon and generally designated by the reference number 10 will be described.

Referring to FIGS. 1 through 12 a preferred embodiment of the present componentized assemblable wall hanging and method of enabling printing thereupon 10 is illustrated.

The present componentized assemblable wall hanging 10 has been devised to enable printing of large images onto an expansive anterior surface of a wall hanging in a single print run while enabling disassembly after printing for shipping of the wall hanging to an end user whereby the wall hanging is reassemblable for installation upon a wall surface. Thus large, complex wall hangings of size and mass are printable and shippable relatively economically.

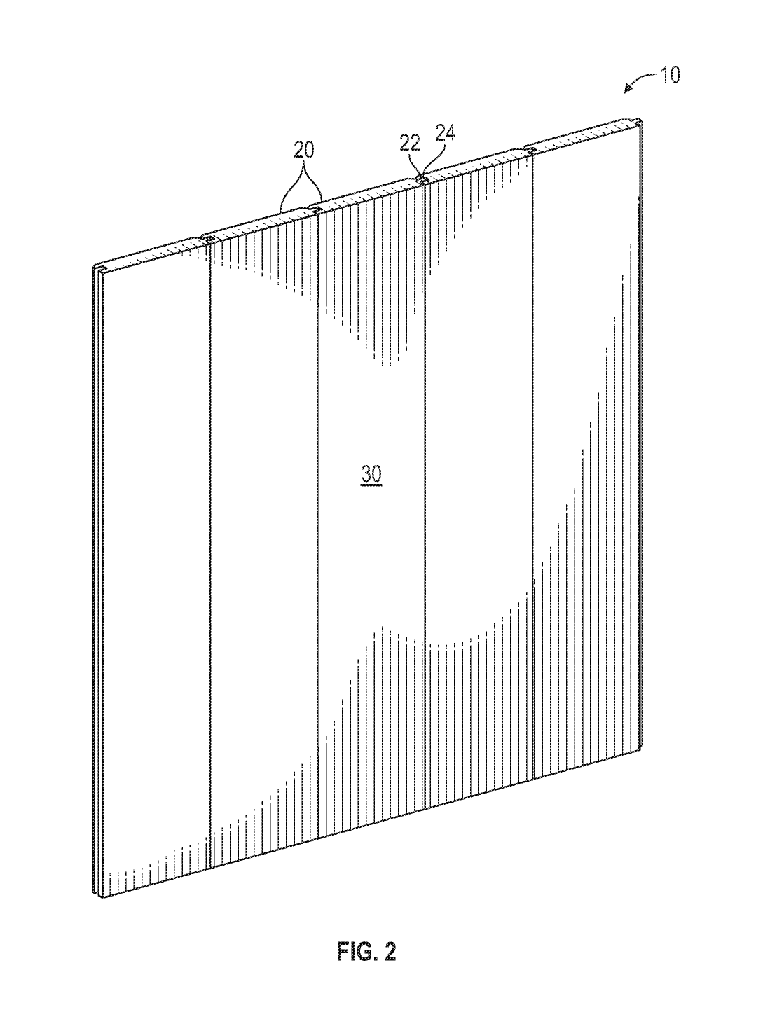

The present componentized assemblable wall hanging 10, therefore, includes a plurality of slat members 20 adjacently connectable by edge-to-edge engagement whereby a flat anterior surface 30 and a posterior surface 40 are maintained. For example, see FIGS. 1 and 2. Each of the plurality of slat members 20 is securable edge-to-edge, adjacently together, for example by sliding engagement of tongue 22 and grove 24 joints machined to maintain securement of the slat members together to present a flush anterior surface 30 occupying a congruent plane for reception of a printer head 100 thereupon, as will be described subsequently.

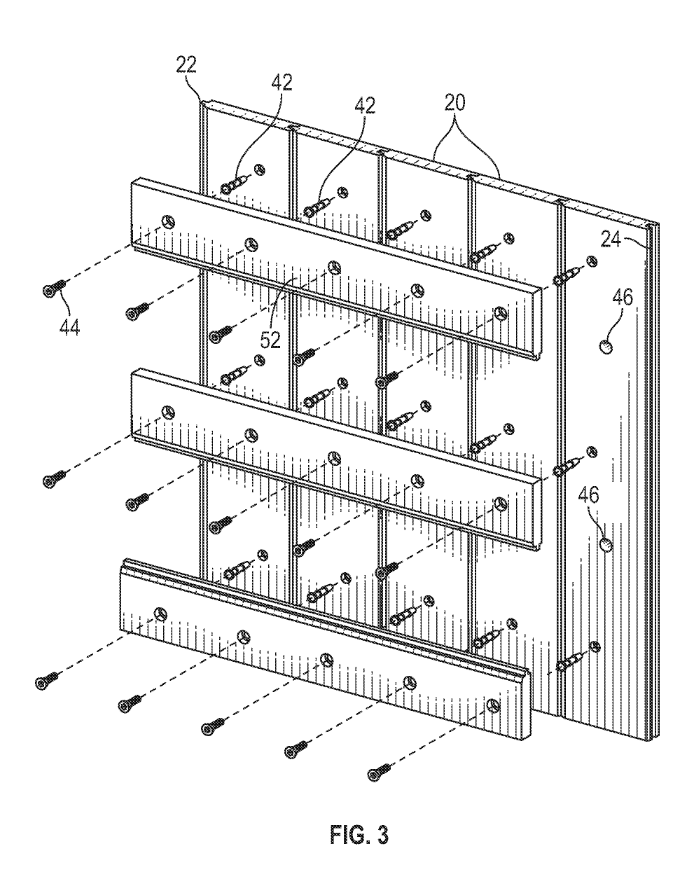

As shown in FIGS. 2 and 3, a plurality of threaded inserts 42 is disposed countersunk into the posterior surface 40 of the plurality of slat members 20. Each of the plurality of threaded inserts 42 is devised to receive a fastener 44 rotationally securable therein whereby each of a plurality of rearward transverse strut members 50 is securable to the posterior surface 40 at pre-scored positions. Each of the rearward transverse strut members 50 is thereby disposed to secure the plurality of slat members 20 tautly together when each of the plurality of fasteners 44 is secured through each of the plurality of rearward transverse slat members 50 into a corresponding one of the plurality of threaded inserts 42 disposed countersunk in the posterior surface 40.

Each of the countersunk threaded fasteners 44 enables repeated assembly and disassembly of the apparatus without loss of threaded engagement interior to the threaded inserts 42 with repeated use and reuse whereby the componentized assemblable wall hanging 10 may be assembled and disassembled frequently without each of the plurality of fasteners 44 losing coherence engaged interiorly within each of the plurality of threaded inserts 42, as may otherwise occur where fasteners are used directly engaged into a substrate through erosion of the threaded channel.

It should be noted that in a preferred embodiment illustrated herein, when installed, the heads of the plurality of fasteners 44 are maintained sunk beneath the exterior surface of the transverse strut members 50 to enable flush contact with a wall surface to which the assembled componentized assmeblable wall hanging 10 is subsequently installed.

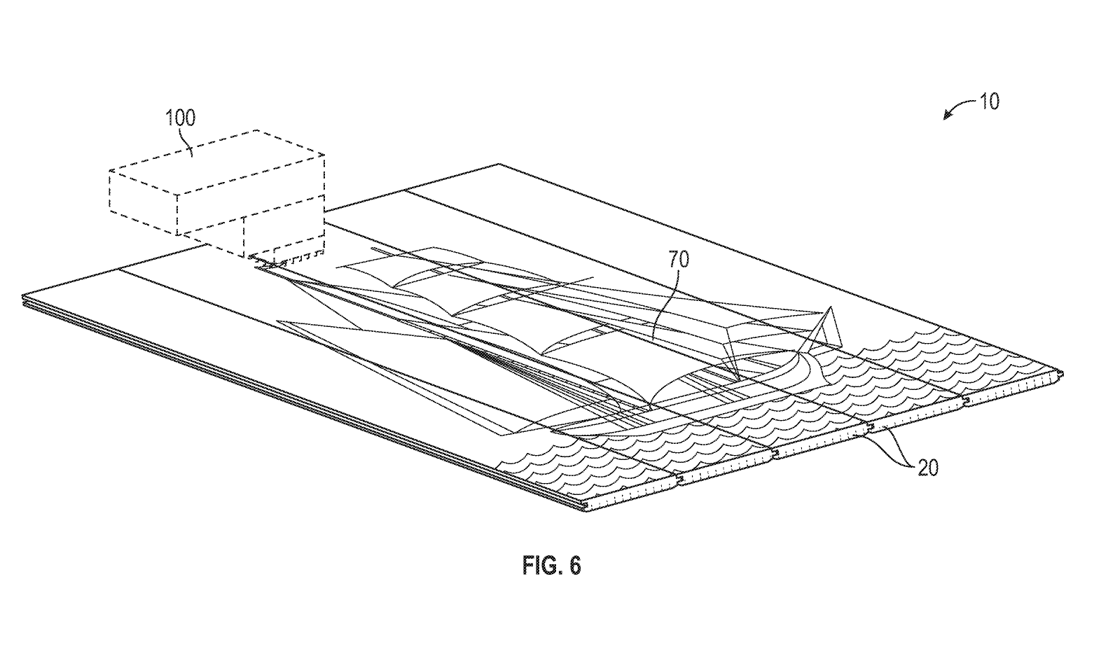

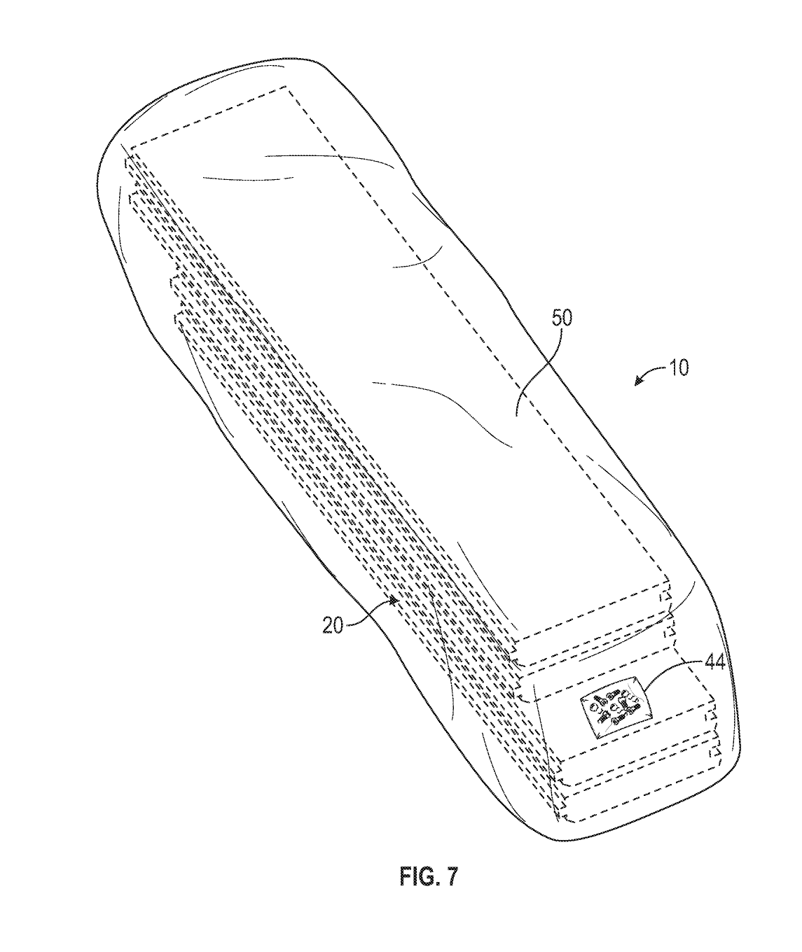

Thus each of the plurality of slat members 20 is maintainable in taut serried contact, edge-to-edge in rows, to present a congruent anterior surface 30 capable of receiving application of a printer head 100 thereto without the printer head 100 effecting a strike due to uneven, incongruent surface deviations as may otherwise occur. For example, see FIG. 6. After printing is completed, as illustrated in FIG. 7, the componentized asseblable wall hanging 10 is subsequently disassemblable for compact shipping. Upon delivery by a customer, the componentized assemblable wall hanging 10 is thence reassembled for installation against a wall with minimal tools (for example a screw driver or an Allen key) required.

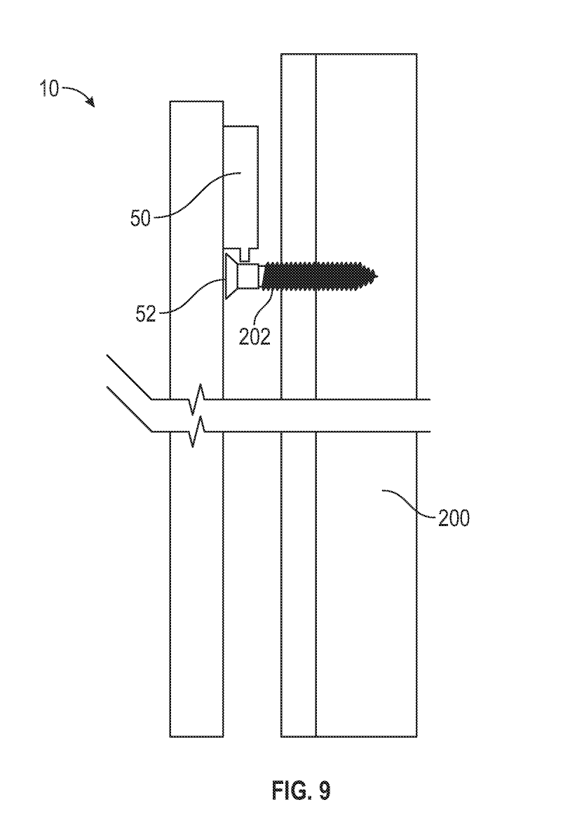

As shown in FIGS. 1 and 3, when installed in portrait orientation, or with each of the plurality of slat members disposed vertically, at least one of the plurality of transverse strut members 50 is engageable to an existing wall fastener, to support the componentized assemblable wall hanging 10 in such orientation. The at least one of the plurality of transverse strut members 50 may include at least one depending point 52 centered, or otherwise positioned in tandem, to enable level suspension of the wall hanging 10. The at least one depending point 52 may include a bevel, recess, or other scoring to enable receipt of a corresponding wall fastener 202 therein and expedite installation to a wall surface 200. Alternately, the at least one transverse strut member 50 may include a tongue 22 disposed thereupon wherein a user may depend the wall hanging from a wall fastener 202 at any depending point 52 therealong, as desired. See for example FIG. 9.

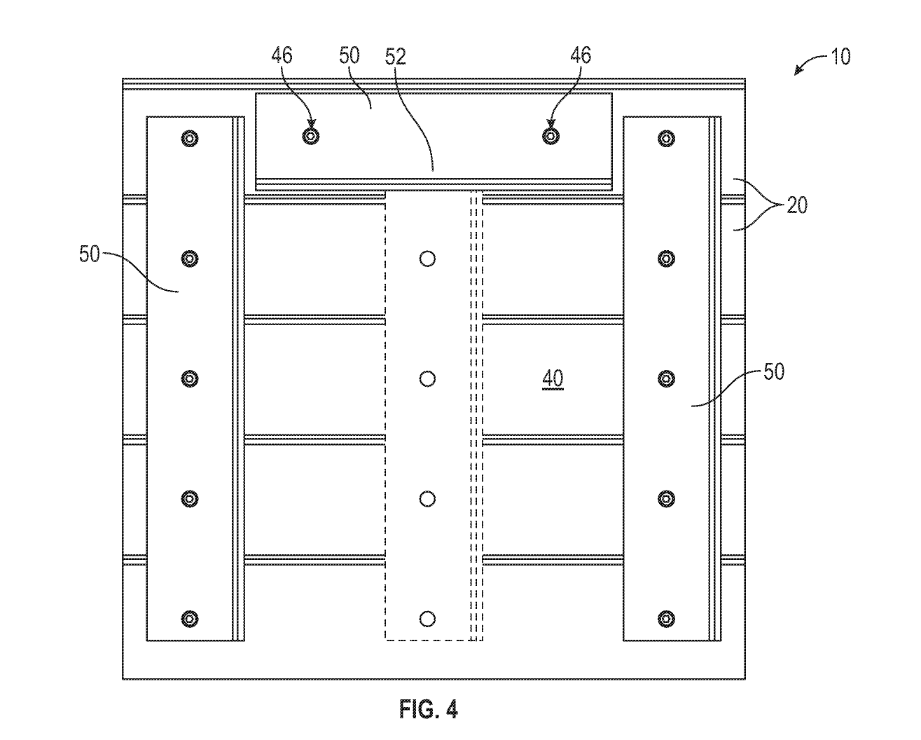

However, when displayed in landscape orientation, or otherwise with each of the plurality of slat members disposed horizontally, at least one of the plurality of slat members 20 includes further threaded inserts 46 disposed longitudinally along the posterior surface 40 for connecting at least one transverse strut member 50 in longitudinal position along the posterior surface 40 of said at least one of the plurality of slat members 20. See FIG. 4. In like manner as described above (and shown in FIG. 9), the at least one of the plurality of transverse strut members may likewise include at least one depending point 52 for expedient level hanging of the device 10. Thus the componentized assemblable wall hanging 10 is securable in a landscape orientation, or other orientation where each of the plurality of slat members is disposed oriented horizontally for view, to a wall fastener in like manner and, importantly, with a same number of parts.

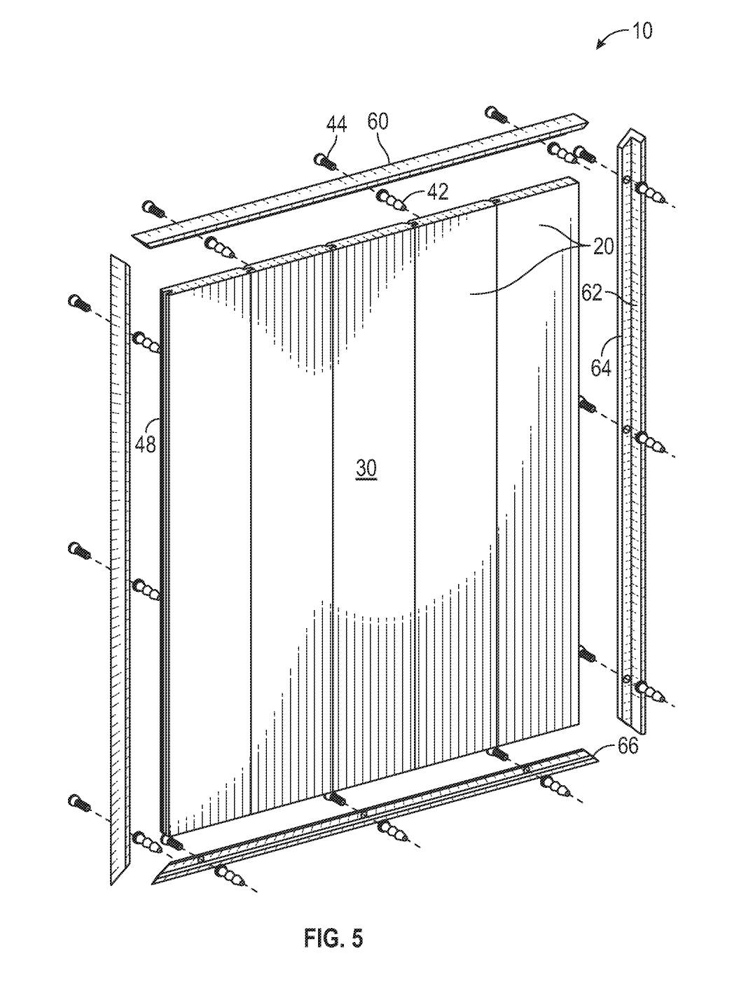

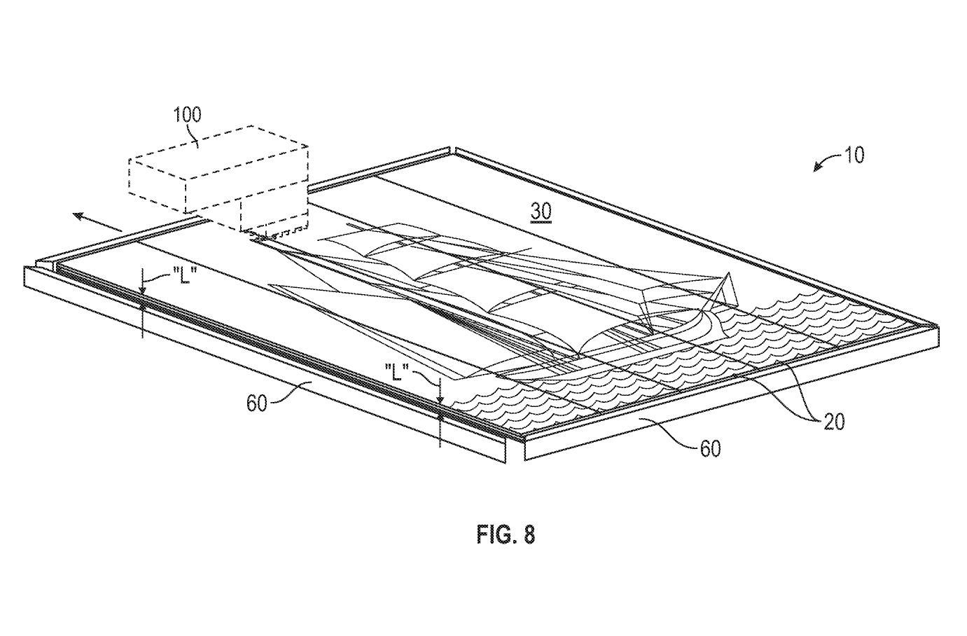

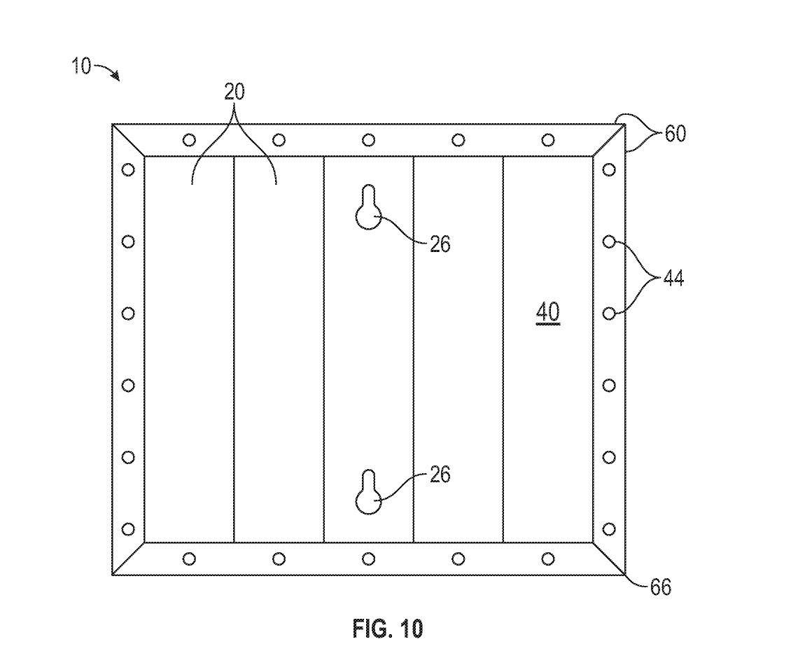

In an alternate embodiment herein contemplated and illustrated in FIGS. 5 and 8, need of the plurality of transverse strut members 40 is obviated by use of a plurality of frame sections 60 disposed to connect together perimetrically bounding the plurality of slat members 20 and thereby maintain each of the plurality of slat members 20 engaged tautly together. Each of the plurality of frame sections 60 includes an inset bead 62 devised to engage along a rearward edge 48 bounding the posterior surface 40 and a right-angular posterior contact portion 64 disposed to overlie the posterior surface 40. The inset bead 62 is disposed at height h relative the posterior contact portion 64. As shown in FIG. 10, fasteners 44 are securable through the posterior contact portion 64 into underlying countersunk threaded inserts 42 disposed upon the posterior surface 40 in corresponding array to receive said fasteners 44 and thereby secure the frame sections 60 tautly engaged whereby the anterior surface 30 is maintained congruently bounded thereby.

Each of the plurality of frame sections 60 engages together at forty-five degrees (45°) diagonal cuts 66 disposed at each end of each of said plurality of frame sections 60 whereby the plurality of frame sections 60 nest together to form a perimetric border tautly framing the content of the image or design 70 disposed upon the anterior surface 30.

Importantly, when installed, each of the plurality of frame sections 60 is disposed to secure to the posterior surface 40 set back a definite distance h from the anterior surface 30, whereby the printer head 100 moving across the anterior surface 30 during application of the image or design 70 thereto remains unimpeded when crossing off and onto the anterior surface 30. See specifically FIG. 8. Thus the anterior surface 30 is maintained outfacing from the frame sections 60 a definite distance h, for example one-sixteenth ( 1/16^{th}) of an inch, to enable free passage of the printer head and printing upon the anterior surface 30 in a single print run.

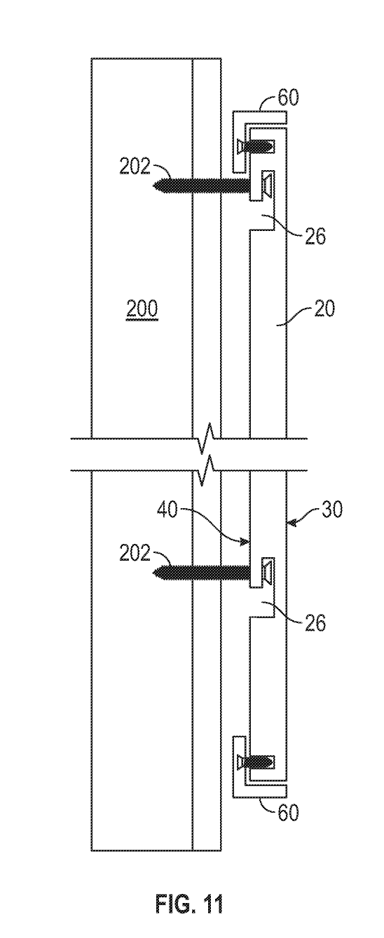

Installation of this embodiment of the present componentized assemblable wall hanging is shown in FIG. 10. At least one of the plurality of slat members 20 includes a plurality of keyhole slots 26 disposed upon the posterior surface 40. Each of the plurality of keyhole slots 6 is thereby engageable upon each of a corresponding plurality of wall fasteners 202 disposed in a wall surface 200 for suspension of the wall hanging thereupon. See FIG. 11.

Thus the plurality of frame sections 60 maintains each of the plurality of slat members 20 in taut serried, edge-to-edge contact to present a congruent anterior surface 30 capable of receiving application of a printer head 100 thereto without said printer head 100 effecting a strike due to any substantially uneven, incongruent surface deviations as would otherwise occur when printing on an anterior surface 30 comprised of independent, longitudinal slat members 20 adjacently connected. After printing is completed, the componentized asseblable wall hanging 10 is disassemblable for compact shipping. Upon delivery, the componentized assemblable wall hanging 10 is thence reassemblable for installation upon a wall surface with minimal tools required (such as a screw driver or Allen key, for example).

Large installations are thereby printable, shippable, and installable at relative efficiency.

In the preferred embodiment herein disclosed, each of the plurality of slat members 20 is comprised of wood, and preferably sustainably sourced or reclaimed wood. A large image is thus printable to a large, wooden wall hanging, whereby aesthetic pleasure may be derived in the home, business, or interior or exterior space, as desired.

A method of printing an image upon an anterior surface of a shippable wall hanging is further contemplated herein and illustrated as FIG. 9. The wall hanging is formed by interconnection of the plurality of slat members secured adjacently together into a plurality of rows and the anterior surface is maintained taut to present a congruent plane for receipt of a printer head thereupon. The plurality of slat members is thus interconnected edgewise together to present a congruent anterior surface and a posterior surface.

Each of the plurality of slat members is secured tautly together by securement of each of a plurality of transverse strut members disposed transversely upon the posterior surface across each of the plurality of rows. The anterior surface is thus maintained taut and flush for receipt of a printer head. The anterior surface is maintained planar without substantial deviations or deformities due to the transverse strut members engaging the plurality of slat members together at scored, countersunk threaded inserts disposed in appropriate position to receivingly engage a corresponding fastener disposed to fasten each of the transverse strut members in requisite position whereby the print head is not stricken during printing of the image to the anterior surface.

Once printing is completed, each of the transverse strut members is removed from the posterior surface and each of the plurality of slat members is disconnected for compact and convenient shipping. Each of the plurality of slat members and transverse strut members is stacked into a compact volume for shipping and sent to the consumer for re-assembly and installation upon a wall, as desired.

Thus each of the plurality of slat members is produced with edges machined for edge-to-edge securement into the plurality of rows. The plurality of threaded inserts is sunk into pre-scored positions upon the posterior surface of the plurality of slat members.

Corresponding transverse strut members; or in the alternative, frame sections; are likewise produced, each with holes devised to position overtop one of the countersunk threaded inserts disposed in the posterior surface whereby appropriate position of each of the plurality of transverse strut and in the alternative, frame sections, members is maintained.

Printing is thus effective upon the anterior surface maintained taut and congruent by action of the plurality of strut members and in the alternative frame sections. Where transverse strut members are preferred, at least one of the transverse strut members may be produced with at least one depending point machined therein, said at least one depending point devised to enable level hanging of the wall hanging once assembled and installed to a wall fastener, or other means of suspending the wall hanging, for view.

Where frame sections are preferred, each of the plurality of frame sections is produced with an inset bead disposed a definite height from a right-angularly disposed posterior contact portion. The height of the inset bead is devised to maintain each frame section set back from the anterior surface to avoid impeding passage of the printer head thereover. At least one of the frame sections may also include at least one depending point machined therein to likewise enable level hanging expediently after reassembly for installation or, alternatively, at least one of the plurality of slat members may include a plurality of keyhole slots disposed upon the posterior surface for engagement with a corresponding plurality of wall fasteners.

Once printing is completed, the plurality of slat members are disassembled and packaged for shipping. Upon receipt at delivery, the wall hanging is reassemblable with minimal tools required.

What is claimed is:

1. A componentized assemblable wall hanging comprising:
a plurality of slat members adjacently connectable edge-to-edge to maintain a flat, congruent anterior surface and a posterior surface;
a plurality of threaded inserts disposed countersunk into the posterior surface; and
a plurality of rearward transverse strut members securable to the posterior surface, each of said rearward transverse strut members disposed to secure the plurality of slat members tautly together in edge-to-edge contact when each of a plurality of fasteners is secured through each of the plurality of rearward transverse slat members into a corresponding one of the plurality of threaded inserts disposed countersunk in the posterior surface;
wherein each of the plurality of slat members is maintainable in taut serried edge-to-edge contact to present a congruent anterior surface capable of receiving application of a printer head thereto without said printer head being stricken due to uneven, incongruent surface deviations, whereby the componentized asseblable wall hanging is disassemblable after printing thereto, compactly packable, and readily shippable to a customer for expedient reassembly upon delivery.

2. The componentized assemblable wall hanging of claim 1 wherein at least one of the plurality of transverse strut members is engageable to a wall fastener to support the componentized assemblable wall hanging in portrait orientation thereupon.

3. The componentized assemblable wall hanging of claim 2 wherein at least one of the plurality of slat members includes further threaded inserts disposed for connecting at least one transverse strut member longitudinally along the posterior surface of said at least one of the plurality of slat members, whereby the componentized assemblable wall hanging is securable in a landscape orientation to the wall fastener.

4. The componentized assemblable wall hanging of claim 3 wherein the plurality of slat members are adjacently securable by edgewise engagement along corresponding tongue and groove joints.

5. The componentized assemblable wall hanging of claim 4 wherein the plurality of slat members are comprised of wood.

6. The componentized assemblable wall hanging of claim 5 wherein the wood is sustainably sourced.

7. A componentized assemblable wall hanging comprising:
a plurality of slat members adjacently connectable to maintain a flat anterior surface and a flat posterior surface;
a plurality of threaded inserts disposed countersunk into the posterior surface; and
a plurality of frame sections disposed to connect together perimetrically bounding the plurality of slat members, said plurality of frame members securable together to thereby maintain the plurality of slat members tautly together, said plurality of frame members disposed to set back a definite distance from the anterior surface;
wherein each of the plurality of slat members are maintainable in taut serried contact to present a congruent anterior surface capable of receiving application of a printer head thereto without the printer head being stricken due to uneven, incongruent surface deviations, whereby the componentized asseblable wall hanging is thence disassemblable, compactly packable, shippable, and reassemblable upon delivery by a customer.

8. The componentized assemblable wall hanging of claim 7 wherein the plurality of slat members are adjacently securable by edgewise engagement along corresponding tongue and groove joints.

9. The componentized assemblable wall hanging of claim 8 wherein the each of the plurality of frame sections secures together by endwise interconnection along a 45° cut.

10. The componentized assemblable wall hanging of claim 9 wherein each of the plurality of frame sections includes a posterior contact portion, disposed to contact the posterior surface of the plurality of slat members and secure thereto, and an inset bead disposed rightangularly upon the posterior contact portion extended a definite height from the posterior contact portion, whereby each of the plurality of frame sections is disposed set back from the anterior surface when installed, sufficient to enable free passage of the printer head thereover.

11. The componentized assemblable wall hanging of claim 10 wherein the plurality of slat members are comprised of wood.

12. The componentized assemblable wall hanging of claim 11 wherein the wood is sustainably sourced.

13. A method of printing an image upon an anterior surface of a shippable wall hanging, said wall hanging formed by interconnection of a plurality of slat members adjacently secured together in edge-to-edge contact, said anterior surface maintained to present a congruent plane for receipt of a printer head thereupon, said method comprising the steps of:
producing a plurality of slat members with longitudinal edges machined for mating edge-to-edge securement;
inserting a plurality of threaded inserts into a posterior surface of each of the plurality of slat members at pre-scored locations;
connecting each of the plurality of slat members adjacently serried together into a plurality of rows, said plurality of slat members interconnected edgewise together to present a congruent anterior surface and a posterior surface;
securing each of the plurality of slat members tautly together by attachment of each of a plurality of transverse strut members secured transversely upon the posterior surface across each of the plurality of rows, each of said plurality of transverse strut members manufactured for securement to the posterior surface by insert of each of a plurality of fasteners into a corresponding one of the plurality of threaded inserts;
presenting the anterior surface for receipt of a printer head, said anterior surface maintained planar without substantial deformities whereby the print head is not stricken during printing of the image to the anterior surface;
removing each of the transverse strut members from the posterior surface after printing has completed and disassembling each of the plurality of slat members from edge-to-edge contact;
packing the plurality of slat members and transverse strut members into a compact volume for shipping; and
shipping the compact volume to an end-user for re-assembly and installation upon a wall fastener;
wherein large wall hangings are asseblable for printing and disassemblable for packed shipping and subsequent reassembly upon delivery.

14. The method of claim 13 wherein the shippable wall hanging is comprised of sustainably sourced or reclaimed wood.

15. A method of printing an image upon an anterior surface of a shippable wall hanging, said wall hanging formed by interconnection of a plurality of slat members adjacently secured together in edge-to-edge contact, said anterior surface maintained to present a congruent plane for receipt of a printer head thereupon, said method comprising the steps of:
producing a plurality of slat members with longitudinal edges machined for mating edge-to-edge securement;
inserting a plurality of threaded inserts into a posterior surface of each of the plurality of slat members at pre-scored locations for receiving engagement of each of a plurality of frame sections;
connecting each of the plurality of slat members adjacently serried together into a plurality of rows, said plurality of slat members interconnected edgewise together to present a congruent anterior surface and a posterior surface;
securing each of the plurality of slat members tautly together by securement of each of a plurality of frame members disposed to border the anterior surface perimetrically, fasten to each of the plurality of threaded inserts, and maintain tautness of the plurality of slat members in edge-to-edge contact;
presenting the anterior surface for receipt of a printer head, said anterior surface maintained planar without substantial deformities whereby the print head is not struck during printing of the image to the anterior surface;
removing each of the plurality of frame sections from the posterior surface after printing has completed and disassembling each of the plurality of slat members;
packing the plurality of slat members and frame sections into a compact volume for shipping; and
shipping the compact volume to an end-user for re-assembly and installation upon a wall fastener;
wherein large wall hangings are asseblable for printing and disassemblable for packed shipping and subsequent reassembly upon delivery.

16. The method of claim 15 wherein the shippable wall hanging is comprised of sustainably sourced or reclaimed wood.

17. The method of claim 16 wherein each of the plurality of frame sections is comprised of a material different than each of the plurality of slat members.
